(19) United States
(12) Patent Application Publication
(10) Pub. No.: US 2002/0178218 A1
(43) Pub. Date: Nov. 28, 2002

(54) Method of browser-server communication

(76) Inventor: Stefan Butlin, Cambridge (GB)

Correspondence Address: William M. Lee, Jr., Lee, Mann, Smith, McWilliams, Sweeney & Ohlson, P.O. Box 2786, Chicago, IL, 60690-2786, US

(21) Appl. No.: 10/151,190

(22) Filed: May 20, 2002

(30) Foreign Application Priority Data
May 24, 2001 (GB) 0112759.6

(51) Int. Cl. G06F 15/16

(52) U.S. Cl. 709/203; 709/219

(57) ABSTRACT

Disclosed is a method of browser-server communication in a communication system (10, 120) comprising browser (40), server (50) and remote server (170), and operable to transmit via HTTP channels (85, 100, 150) content and/or software in response to corresponding requests therefor between browser (40) and server (50) and/or remote server (170), characterized by the steps of:

(1) identifying at server (50) and/or remote server (170) availability of content and/or software, issuing notifying instructions therefrom via private communication channels (90, 160) to browser (40) indicative of said content and/or software;

(2) transmitting fetching instructions in response to said notifying instructions from browser (40) to server (50) and/or remote server (170) to fetch said content and/or software;

(3) transmitting from server (50) and/or remote server (170) said content and/or software to browser (40); and

(4) receiving said content and/or software at browser (40).

The present invention relates to a method of browser-server communication and in particular, but not exclusively, to a method of communication between an Internet-compatible microbrowser executable on a handset and a server executable on at least one of the handset and an Internet web site. The server can be any Hypertext Transfer Protocol (HTTP) compatible server.

### BACKGROUND TO THE INVENTION

Communication between browsers and servers in the Internet environment is currently implemented solely using HTTP where the browsers only implement a client role, namely provide an interfacing role from associated clients to the Internet, and the servers only implement a serving role, namely to provide data in response to receiving instructions from one or more clients. Presently, there is no mechanism whereby the servers can contact the browsers asynchronously, namely contact the browsers other than in direct response to direct requests issued by the clients via their browsers.

The inventor has appreciated that it would be especially beneficial for subsidiary activities, often referred to as side events, at or associated with the servers to be able to update contents displayed at the browsers to their associated clients. Such side events could be, for example, associated with modifying icons displayed to a client via his or her associated browser or upgrading facilities provided by a browser to an associated client.

The inventor has appreciated that conventional approaches potentially exist to address the problem of side events updating browsers.

A first conventional approach involves establishing open connections from browsers to servers which are not closed by the servers due to inactivity, the browsers requesting content from the servers. The servers are thereby capable of periodically supplying data to the browsers as and when the servers receive such data from their associated side events. The first conventional approach suffers drawbacks in that browsers are susceptible to timing out on connections to servers, and Internet communication channels are tied up for relatively long periods of time with relatively low data transfer rates occurring therealong and thereby resulting in Internet communication capacity being used inefficiently.

A second conventional approach is to rely on open connections as above and to employ JavaScript. JavaScript corresponds to browser-executable software. However, this second approach requires that browsers should be capable of supporting JavaScript execution. Not all contemporary browsers can support JavaScript, especially proprietary microbrowsers suitable for executing on mobile handsets.

### SUMMARY OF THE INVENTION

According to a first aspect of the present invention, there is provided a method of browser-server communication in a communication system comprising browsing means and serving means, the system being HTTP based for transmitting requests from the browsing means for one or more of content and software via HTTP communicating means to the serving means, and for receiving said one or more of content and software back from the serving means via the HTTP communicating means, the method characterised in that it includes the steps of:

(1) identifying at the serving means availability of at least one of supplementary content and executable software, issuing notifying instructions therefrom via private communicating means to the browsing means indicative of at least one of the supplementary content and executable software;

(2) transmitting in response to receiving the notifying instructions corresponding getting instructions from the browsing means to the serving means to fetch at least one of the supplementary content and the executable software;

(3) transmitting from the serving means at least one of the supplementary content and executable software to the browsing means; and

(4) receiving at least one of the supplementary content and the executable software at the browsing means.

The invention is of advantage in that the serving means is capable of asynchronously notifying the browsing means of at least one of the supplementary content and executable software in the context of the system being HTTP-based for fetching content from the serving means on instruction from the browsing means.

HTTP standards are provided in an international specification having reference RFC2616 which is herein incorporated by reference.

The aforesaid supplementary content include one or more of HTML-type content files, emails, data, image data such as video and sound and bit images. The aforesaid executable software includes plug-ins, for example video animation plug-ins, sound plug-ins. The private communicating means is distinguished from standard HTTP communicating means conventionally employed for Internet communication in that it can convey customized control labels and instructions which are not supported through contemporary HTTP channels employed for browser-server communication.

Preferably, at least one of the supplementary content and the executable software is handled in a similar manner to other Internet information and data. Therefore, the notifying instructions preferably include a uniform resource locator (URL) indicative of an address at which at least one of the supplementary content and executable software is accessible and inviting the user to request the URL.

The method is preferably capable of notifying users of at least one of the supplementary content and the executable software arising by way of one or more side events at the serving means Side events include other users contacting the serving means with messages such as e-mails for example, and software operating on the serving means which periodically generates messages and data, for example stock market investment programs.

Preferably, the system includes a handset including processing means, the browsing means being implemented as microbrowser software executable on the processing means, and the serving means being implemented as at least one of:

(a) a microserver executable on the processing means; and

(b) one or more remote servers remote from the handset.

The method is applicable, for example, to mobile telephones thereby enabling telephone users to be notified of supplementary content and executable software, for example incoming e-mails, available on the Internet. In such an application, it is preferable that the handset includes radio communicating means for connecting the browsing means to the one or more remote servers.

The supplementary content can, for example, be dormant executable software present ab initio in the handset. Thus, preferably, at least one of the supplementary content and the executable software is already present in data storing means associated with the microserver, the remote server operable via the private communicating means to inform the user via the browsing means of at least one of the supplementary content the executable software. By employing the method, a manufacturer of the handset is capable of subsequently remotely activating software present in the handset, for example as on-going system upgrades.

Preferably, in order to enable remote interrogation of the handset, one or more of the remote servers are operable to request at least one of content and executable software via the private communicating means from storing means associated with at least one of the microserver and the microbrowser. Such communication via the private communicating means enables the one or more remote servers to be able to interrogate the handset to determine its present configurational status, for example to determine whether or not to inform the user of the handset that a software upgrade is required.

The supplementary content can be of varied form. It preferably comprises one or more of HTML-type content, data, image data and numerical data. The executable software preferably includes plug-ins. Preferably, the plug-ins are compatible with one or more the serving means and the browsing means for enhancing their functionality.

When the serving means notifies the user of one or more of the supplementary content and the executable software, it is often desirable that the user should not be disturbed from a task he or she is presently performing. Thus, preferably, at least one of the supplementary content and the executable software is presented to the user by way of a popup image. When popup images are employed, it is desirable that these are cancelled after a period to prevent a display associated with the browsing means being cluttered with popup images. Thus, preferably, the serving means is operable to issue subsequent closing instructions via the private communicating means for closing the popup image. Alternatively, the popup can be automatically cancelled after a pre-set period.

It is preferable that present HTTP-based systems are upgradable to implement the aforesaid method of the invention. Thus, beneficially, the method includes the step of upgrading at least one of the serving means and the browsing means to enable subsequent communication via the private communicating means.

Conveniently, especially when the method is employed in conjunction with mobile telephones, the browsing means preferably has associated therewith displaying means for presenting graphical images to the user, the displaying means being partitioned into a first display area for displaying HTML content and a second display area for displaying non-HTML content. Preferably, the first and second areas are mutually exclusive in the displaying means. Alternatively, the first and second regions are preferably at least partially overlapping.

According to a second aspect of the present invention, there is provided communication system operable according to a method of the first aspect of the invention.

### DESCRIPTION OF THE DRAWINGS

Embodiments of the invention will now be described, by way of example only, with reference to the following diagrams in which:

FIG. 1 is a schematic diagram of a microbrowser and a microserver interconnected together and included within a handset;

FIG. 2 is a schematic diagram of a microbrowser and a microserver included within a handset interconnected via wireless interfaces to a server remote from the handset;

FIG. 3 is a schematic diagram of message exchange between a browser and a server for enabling the server to inform the browser of the arrival of a new e-mail; and

FIG. 4 is a schematic diagram of message exchange between a browser and a server for enabling the server to display a new page.

### DESCRIPTION OF THE EMBODIMENTS

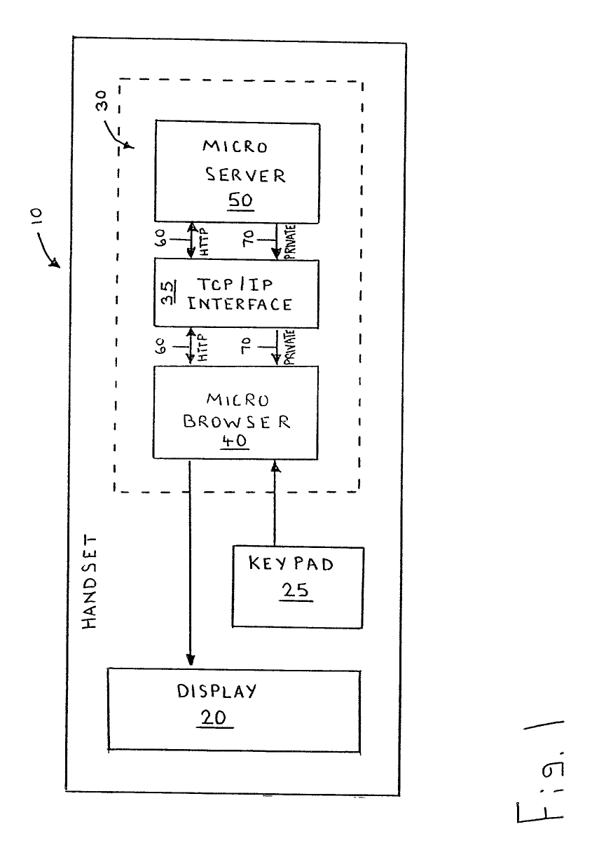

Referring to FIG. 1, there is illustrated a handset indicated generally by 10. The handset 10 comprises a display 20 and a keypad 25 connected to an on-board microprocessor 30 comprising a memory section and a processing section. The memory section includes one or more of random access memory (RAM), non-volatile memory such as electrically erasable programmable read only memory (E²PROM) and read-only memory (ROM). In the memory section, there is stored microbrowser software 40, for example a modified version of ViewML; standard ViewML is available from Century Software Inc. of the USA or Compact Netfront available from Access Inc. of the USA. Moreover, there is also stored in the memory section microserver software 50, for example a modified version of Web Server; Web Server is available from Bellevue Inc, a company based in Washington, USA. The microbrowser 40 and the microserver 50 are interconnected by way of a data link 35 operating under hypertext transfer protocol (HTTP). The link 35 is capable of supporting data exchange via a conventional HTTP channel 60 at request of the microbrowser software 40 in a conventional manner. Moreover, the link 35 is also capable of supporting instruction exchange at the request of the microserver software 50 in an unconventional manner via a private channel 70. HTTP is defined in an internationally agreed standard having reference RFC2616 which is herein incorporated by reference.

In operation, a user of the handset 10 views the display 20 and controls the handset 10 using the keypad 25. The user inputs instructions via the keypad 25 to the microbrowser software 40 to communicate via the conventional channel 60 with the microserver software 50, such communication conforming to HTTP. These instructions access content, for example hypertext markup language (HTML) files and image files, stored within the memory section which the microserver software 50 communicates back via the conventional channel 60 to the microbrowser software 40 for formatting for subsequent presentation on the display 20.

When employing the conventional channel 60, the microbrowser software 40 acts on behalf of the user to present requests for content to be provided from the microserver software 50 which functions then in a serving role.

There arises in the handset 10 side events as described earlier, for example the user installs an additional ROM into the handset 10 which supplements the content already stored therein with one or more of supplementary content and additional executable software such as plug-ins. When the user re-activates the handset 10, the microbrowser software 40 will not initially be aware of the supplementary content and additional software, and therefore will not initially show any indication of the supplementary content and additional software on the display 20, for example an additional icon.

The aforementioned modifications to the microserver software 50 and the microbrowser software 40 enable the handset 10 in operation to inform the user of the supplementary content and additional software. The modifications enable the microserver software 50 to detect the presence of the supplementary content and additional software and to proceed to send a message via the private channel 70 to the microbrowser software 40 to update information presented to the user on the display 20, or perform some other query or action, for example raising an audible alarm such as a bleep. The user thereby becomes aware of the supplementary content and the additional software, and then instructs the browser software 40 to acquire via the HTTP channel 60 one or more of the supplementary content and the additional software from the microserver software 50 in a normal manner. If desired, the microbrowser software 40 can be configured to respond automatically to the message sent from the microserver software 50 to request one or more of the supplementary content and additional software without the user needing to submit instructions; such automatic response results, for example, in icons automatically appearing on the display after an additional ROM module is installed in the memory section.

It will be appreciated that the private channel 70 enables the microserver software 50 to function in an unconventional manner in that it is capable of sending instructions to the microbrowser software 40, such backward directed instructions not being supported by the conventional HTTP channel 60. Thus, in effect, the microserver software 50 is capable of functioning as a browser and the microbrowser software 40 is capable of functioning as a server when side events generate one or more of new content and additional software.

The handset 10 thereby enables the user to be kept updated of supplementary content entering into the memory section of the on-board processor 30. It is to be appreciated that the supplementary content can enter the handset in a number of ways, an additional ROM installed by the user into the handset 10 representing only one such way.

By maintaining the conventional HTTP channel 60 and supplementing it with the private channel 70, compatibility with existing systems based on HTTP links is thereby achieved.

It will be appreciated that although the microbrowser software 40 and the microserver software 50 are executed on a single microprocessor within the handset 10, the handset 10 can be modified to include first and second microprocessors, the first processor for executing the microbrowser software 40 and the second processor for executing the microserver software 50. Using a plurality of microprocessors is of advantage in that each of the first and second processors can be optimized for performing its associated function, for example image display and data retrieval.

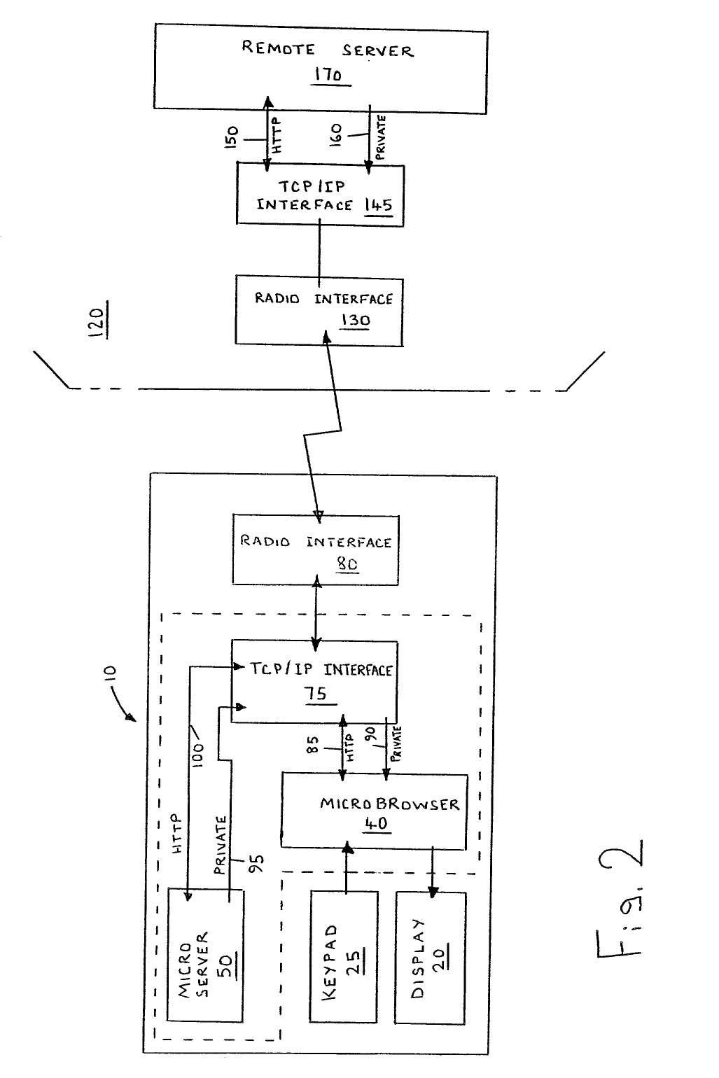

The handset 10 is preferably implemented as a mobile telephone as illustrated in FIG. 2, where the handset 10 additionally includes a transfer control protocol/Internet protocol (TCP/IP) interface 75 connected to a bi-directional radio interface 80. The microbrowser software 40 is coupled via a conventional HTTP channel 85 and also via a private channel 90 to data transfer sockets of the TCP/IP interface 75. Likewise, the microserver software 50 is coupled via a conventional HTTP channel 100 and also via a private channel 95 to data transfer sockets of the TCP/IP interface 75. The channels 85, 90, 95, 100 and the TCP/IP interface 75 are implemented in layers of software which are operable to access hardware such as memory and input/output buffers within the handset 10.

The TCP/IP interface 75 is itself connected to a bi-directional radio interface 80 via a packet carrier implemented as a layer of software. The radio interface 80 includes antennae and associated radio circuits such as modulators, demodulators, amplifiers and oscillators which enable it to communicate with Internet infrastructure denoted by 120. The Internet infrastructure 120 includes a bi-directional radio interface 130 coupled via a packet carrier and TCP/IP interface 145 implemented in layers of software and thereafter via a conventional HTTP channel 150 and a private channel 160 to a remote server 170. The remote server 170 can be, for example, another mobile telephone or a fixed Internet web site implemented in a web server.

The remote server 170 via the radio interfaces 80, 130 and the TCP/IP interfaces 75, 145 is capable of functioning in a similar manner to the microserver software 50, thereby enabling the following operations to be executed:

(a) the user of the handset 10 enters instructions via the keypad 25 which are received by the microbrowser software 40;

(b) the microbrowser software 40 in turn is operable to emit an HTTP command via the HTTP channels 85, 150 and the interfaces 75, 80, 130, 145 to the remote server 170;

(c) the remote server 170 interprets the command and sends content back via the HTTP channels 85, 150 and the interfaces 75, 80, 130, 145 back to the microbrowser software 40;

(d) the microbrowser software 40 formats the content and finally presents the content on the display 20 for the user to view.

On account of the microserver software 50, the server 170 and the microbrowser software 40 being of specially modified form, the handset 10 and the infrastructure 120 are additionally capable of coping with side events as will now be described.

When side events within the remote server 170 modify content therein, the server 170 is operable to send one or more instructions via the private channels 90, 160 and the interfaces 75, 80, 130, 145 to the microbrowser software 40 to present a prompt, for example an icon, on the display 20 informing the user that new supplementary content is available on the remote server 170. The user is then able to enter instructions at the keypad 25 which are forwarded by the browser software 40 back via the HTTP channels 85, 150 and the interfaces 75, 80, 130, 145 to the remote server 170.

The handset 10 can be further modified so that, subject to authorisation for example using private-public key authentication, the remote server 170 is capable of employing the private channels 95, 160 and the interfaces 75, 80, 130, 145 to at least one of store and access one or more of content and software directly within the memory section of the processor 30. The remote server 170 is thereby capable of uploading software and data upgrades into the handset 10, such software and data being accessible to the user by the user invoking the microbrowser software 40 to interrogate the microserver software 50 via the conventional HTTP channels 85, 100 and the interface 75.

The remote server 170 and its associated interfaces 130, 145 can, as described earlier, be a remote handset whose user is able to write content, for example one or more of text messages and graphical images, to the handset 10 for storing therein, the user of the remote handset causing via the private channels 90, 160 and the microbrowser software 40 an icon to be presented on the display 20 prior to sending the content to the handset 10. The user of the handset 10 can thereby be prompted via an icon that there is an incoming message and then fetch the message using the microbrowser software 40 in a conventional manner. Optionally, the microbrowser software 40 can be configured to fetch automatically the content and present it on the display 20.

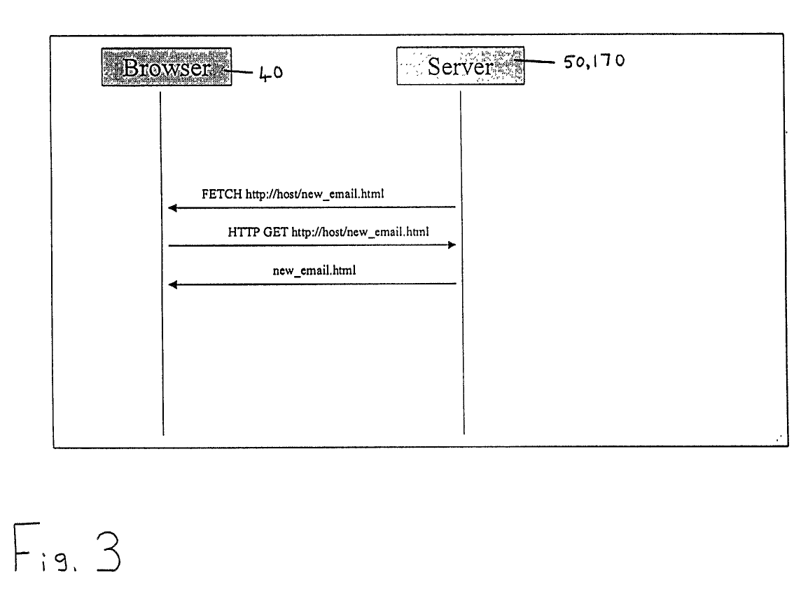

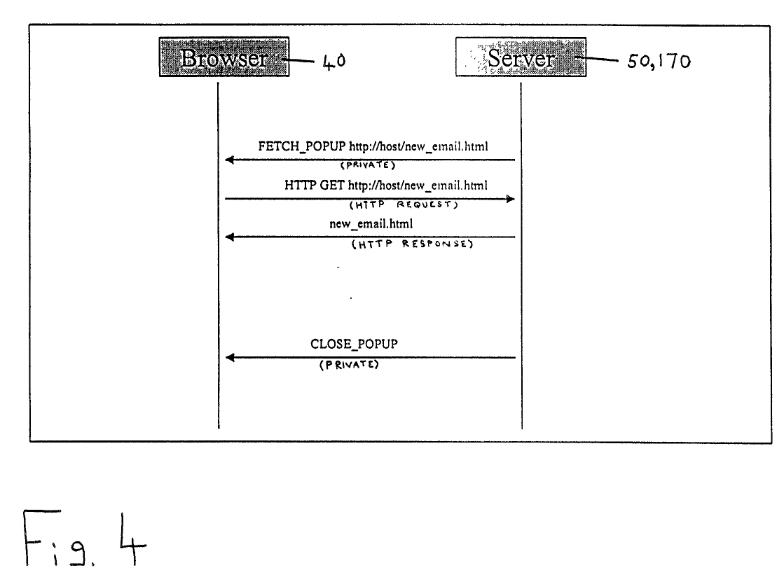

An example of an e-mail sent as content will now be described with reference to FIGS. 3 and 4.

An e-mail is received at the server 170 as a result of a side event. A current page displayed by the microbrowser software 40 on the display 20 needs updating in order to alert a user of the handset 10 of the arrival of the e-mail. To provide such updating, the server 170 sends a message via the private channels 90, 160 and the interfaces 75, 80, 130, 145 to the microbrowser software 40, the message being of the form “new_mail.html” implemented in accordance with HTTP. The microbrowser software 40 then interprets the message and proceeds to display the message on the display 20. Such private connection for conveying the message can, for example, be established at power-up of the handset 10 or on demand mid-way during a communication session.

The message is preferably a single byte code followed by a uniform resource locator (URL) inviting the microbrowser software 40 and hence the user to request the URL using a normal HTTP request, namely by sending a GET command to fetch “new_email.html”, via the HTTP channels 85, 150 and the interfaces 75, 80, 130, 145 to the server 170. The server 170 then proceeds to send the e-mail, namely an HTTP response message for “new email.html” via the HTTP channels 90, 150 which the microbrowser 40 receives and formats for displaying on the display 20.

The handset 10 can be configured so that the e-mail appears in a popup window presented by the microbrowser software 40 on the display 20. Such presentation is of advantage in that the e-mail would not greatly interfere with current browser contents presented on the display 20. Presentation of the e-mail in a popup window can be achieved by using a different byte code indicative to the microbrowser software 40 that the supplied URL should be fetched and displayed in the popup window. A subsequent message can be sent from the server 170 to close the popup window. Alternatively, the popup can be arranged to disappear automatically after a pre-set time period. Such a sequence of events is illustrated in FIG. 4.

In FIG. 4, the server 170 sends a notifying instruction, for example in response to the -occurrence of side events, for “new_email.html” via the private channels 90, 160 to the -microbrowser software 40; in other words, the server 170 tells the microbrowser software 40 to fetch a new URL and display it in a popup window. If required, such notification can be performed as a two-step operation, namely firstly create the popup window and then fill it with information to inform the user. Thus, the microbrowser software 40 presents a popup on the display 20 to inform the user that a new e-mail has been received. The user responds via the keypad 25 causing the browser software 40 to send a HTTP GET instruction for “new_email.html” via the HTTP channels 85, 150 and the interfaces 75, 80, 130, 145 to the server 170; in other words, the browser software 40 responds by initiating an HTTP GET instruction according to a normal HTTP method. The server 170 then proceeds to send a response message for “new_email.html” via the HTTP channels 60, 150 to the microbrowser software 40 which presents the e-mail message within a popup on the display 20 for viewing by the user. Subsequently, some time later, the server 170 issues a “CLOSE_POPUP” instruction via the private channels 90, 160 to the microbrowser software 40 to close the popup window presented on the display 20.

The e-mail, for example an e-mail page, fetched in the examples provided in FIGS. 3 and 4 can be any form of page contents implemented in HTML. The page preferably includes one or more of:

(a) simple information text;

(b) graphics images which can be at least one of static and moving images;

(c) JavaScript commands and associated data;

(d) Java Applets.

Executable software, for example plug-ins such as a video player for presenting animated video images and a music plug-in for playing music at the handset 10, Macromedia Flash graphics and so on, can also accompany the e-mail. Such executable software is required where the e-mail is, for example music data, the music plug-in is required in the handset 10 to receive music data and generate corresponding audible sounds for the user to hear.

The URL presented by the server 170 to the browser software 40 can relate to another site on the Internet, that is a server other than the server 170, or can relate to the microserver software 50 included within the handset 10. For example, content can be stored dormantly within the memory section of the handset 10, for example in a ROM included initially within the handset 10 at the time of its purchase, which is drawn to the user's attention at a later date by action of a remote server on the Internet.

E-mail pages can be conveyed to the handset 10 in association with one or more of the following side events:

(a) arrival of a new message at one or more of the servers 50, 170;

(b) incoming telephone calls;

(c) stock market conditions meeting pre-set thresholds, for example where the hand-set 10 is used by an investment broker or financier; and

(d) the handset is currently in a spatial position where pre-set conditions are satisfied, for example the user is walking near a retailing establishment selling a product which the user seeks below a certain price.

The private channels 90, 95, 160 are preferably employed to perform additional functions, the additional functions including one or more of the following:

(a) pausing and/or resuming applets or plug-ins provided to the handset 10 and executing on its microprocessor 30;

(b) for setting start-up information and settings for the microbrowser software 40, for example on initial power-up;

(c) pushing information to the microbrowser software 40 for providing a prompt, for example an icon, on the display 20 in a non-HTML area thereof, the information for example indicative of battery state, received signal strength and so on;

(d) to send the microbrowser software 40 a shutdown message so as to allow the microbrowser software 40 sufficient time to save into the memory section of the handset 10 important information prior to the microbrowser software 40 execution being terminated;

(e) modifying widget set control, widgets being special executable software modules present in the handset 10 for generating features such as scrollbars, list boxes, buttons, radio check boxes and so on on the display 20; updating of such features can thereby be achieved;

(f) “skin” control, namely overall style of presentation on the display 20, for example colour of the display 20, style of buttons presented on the display 20, and text font and size displayed on the display 20; graphical images presented on non-HTML windows of the display 20 as provided by the microbrowser software 40 are controllable by pushing graphic content or instructions to the microbrowser software 40 regarding which “skin” to use.

It will be appreciated that the display 20 can optionally be partitioned into HTML and non-HTML regions. The non-HTML regions are also referred as native regions of the display 20. Alternatively, the entire display 20 can be configured to be capable of displaying HTML content with a part of the display 20 also being capable of displaying non-HTML content, for example menu bars.

It will be appreciated that operations described above for the server 170 are equally applicable to the microserver 50 included within the handset 10. The private channels 90, 95, 160 can be supported by way of one or more of the following:

(a) conventional transfer control protocol/Internet protocol (TCP/IP);

(b) Multimedia Message System (MMS) protocol as used on contemporary GSM phones; and

(c) Universal Message System (UMS) protocol as used in recent 3G-type mobile telephones.

In the form of communication as described above using one or more of the private channels 90, 95, 160, the remote server 170 can additionally use the private channels to perform one or more of the following:

(a) instruct the microbrowser software 40 to generate a sound or other form of alarm; the private channels are preferably used to convey a byte code indexing a particular sound or to convey an audio stream;

(b) upgrade microbrowser software 40 plug-in support by either uploading new plug-ins to the handset 10 or replacing existing plug-ins; and

(c) initiate pre-loading of pages into the handset 10.

With regard to initiating pre-loading of pages into the handset 10, the microbrowser software 40 can be, for example, a conventional microbrowser incapable of supporting the aforesaid private channels; the pre-loading of pages results in the conventional microbrowser extending its page cache and rendering it capable of receiving instructions via the private channels to fetch pages, for example from the server 170, without displaying them on the display 20 but storing them in a cache memory forming part of the memory section of the microprocessor 30.

It will be appreciated that further modifications can be made to the handset 10 and methods way in which it functions without departing from the scope of the invention.

1. A method of browser-server communication in a communication system comprising browsing means and serving means, the system being HTTP based for transmitting requests from the browsing means for one or more of content and software via HTTP communicating means to the serving means, and for receiving said one or more of content and software back from the serving means via the HTTP communicating means, the method characterised in that it includes the steps of:
(1) identifying at the serving means availability of at least one of supplementary content and executable software, issuing notifying instructions therefrom via private communicating means to the browsing means indicative of at least one of the supplementary content and executable software;
(2) transmitting in response to receiving the notifying instructions corresponding getting instructions from the browsing means to the serving means to fetch at least one of the supplementary content and executable software;
(3) transmitting from the serving means at least one of the supplementary content and executable software to the browsing means; and
(4) receiving at least one of the supplementary content and executable software at the browsing means.

2. A method according to claim 1, wherein the notifying instructions include a URL indicative of an address at which at least one of the supplementary content and executable software is accessible and inviting the user to request the URL.

3. A method according to claim 1 or 2, wherein the serving means is notified of at least one of the supplementary content and executable software by way of one or more side events.

4. A method according to claim 1, 2 or 3, wherein the system includes a handset including processing means, the browsing means being implemented as microbrowser software executable on the processing means, and the serving means being implemented as at least one of:
(a) a microserver executable on the processing means; and
(b) one or more remote servers remote from the handset.

5. A method according to claim 4, wherein the handset includes radio communicating means for connecting at least one of the browsing means and the microserver to the one or more remote servers.

6. A method according to claim 4 or 5, wherein at least one of the supplementary content and executable software is already present in data storing means associated with the microserver, the remote server operable via the private communicating means to inform the user via the browsing means of at least one of the supplementary content and executable software.

7. A method according to claim 4, 5 or 6, wherein one or more of the remote servers are operable to request at least one of content and executable software via the private communicating means from storing means associated with at least one of the microserver and the microbrowser.

8. A method according to any one of the preceding claims wherein the supplementary content comprises one or more of HTML-type content, e-mail, data, image data and numerical data.

9. A method according to any one of the preceding claims wherein the executable software includes plug-ins for at least one of the serving means and the browsing means for enhancing their functionality.

10. A method according to any one of the preceding claims wherein at least one of the supplementary content and executable software is presented to the user by way of a popup image.

11. A method according to claim 10, wherein the serving means is operable to issue subsequent closing instructions via the private communicating means for closing the popup image.

12. A method according to any one of the preceding claims wherein the serving means and browsing means are initially incapable of supporting the private communicating means, the method including the step of upgrading at least one of the serving means and the browsing means to enable subsequent communication via the private communicating means.

13. A method according to any preceding claim, the browsing means having associated therewith displaying means for presenting graphical images to the user, the displaying means being partitioned into a first HTML display area and a second non-HTML area.

14. A communication system operable according to a method according to any one of the preceding claims.

15. A method of browser-server communication in a communication system substantially as hereinbefore described with reference to one or more of FIGS. 1 to 4.

16. A communication system substantially as hereinbefore described with reference to one or more of FIGS. 1 to 4.
